(19) United States
(12) Patent Application Publication
(10) Pub. No.: US 2022/0195794 A1
(43) Pub. Date: Jun. 23, 2022

(54) SECONDARY BLIND CONTROL DEVICE

(71) Applicant: Samuel A. Johnson, Orlando, FL (US)

(72) Inventor: Samuel A. Johnson, Orlando, FL (US)

(21) Appl. No.: 17/130,113

(22) Filed: Dec. 22, 2020

(51) Int. Cl. E06B 9/307

(52) U.S. Cl. CPC E06B 9/307

(57) ABSTRACT

A secondary control device for a venetian blind assembly includes an elongated main body having a plurality of loops extending outward at uniform distances. Each of the loops is pivotally connected to a slat engagement member having a frame and a slat connector. The slat connector includes a body section having an adhesive along the top surface, and a removable covering layer for protecting the adhesive until the device is ready to be installed. When the slat engagement members are secured onto a group of slats, movement of the main body causes the group of slats to transition between the open position and the closed position without affecting the position of the remainder of the blind assembly.

### TECHNICAL FIELD

The present invention relates generally to window fixtures, and more particularly to a secondary control mechanism for venetian-style blinds.

### BACKGROUND

The statements in this section merely provide background information related to the present disclosure and may not constitute prior art.

Venetian blinds are age-old fixtures that are attached to windows and doors to provide privacy, shade, and decoration. As such, the blinds are typically sized so as to conform to the shape of the window in order to selectively cover the same.

As shown at background FIG. 1, a typical commercially available venetian blind 1 includes a plurality of elongated horizontal slats 2 that are stacked vertically between a top-rail 3 and a bottom-rail 4. A plurality of ladder strings 5 extend between the top and bottom rails and engage each of the horizontal slats. The ladder strings are typically coupled to a lift controller 6 for selectively raising and lowering all of the slats, and a tilt controller 7 for selectively tilting all of the slats between an open and a closed orientation.

In this regard, venetian blinds are operable in the following configurations: 1) fully raised=no privacy and no shade on entire window; 2) partially lowered=partial shade and partial privacy on top portion of the window; 3) fully lowered with slats open=partial shade and partial privacy on entire window; and 4) fully lowered with slats closed=maximum shade and maximum privacy on entire window.

Unfortunately, this top down design and the all-or-nothing operation of these blinds does not suit the most commonly needed situation wherein a user wishes to allow maximum light to enter the room via the top of the window, while providing maximum privacy along the middle and bottom portions of the window.

Accordingly, it would be beneficial to provide a secondary blind control mechanism that can be mated with any type of blind in order to alleviate the drawbacks described above.

### SUMMARY OF THE INVENTION

The present invention is directed to a secondary control device for a venetian blind assembly. One embodiment of the present invention can include an elongated main body having a plurality of loops extending outward at uniform distances. Each of the loops can be connected to a slat engagement member having functionality for receiving and engaging a slat of the venetian blind assembly.

In one embodiment, each of the slat engagement members includes a frame that is secured to one of the loops so as to have freedom of movement vertically, horizontally, diagonally and laterally, so as to be able to twist, pivot and rotate with respect to the main body.

In one embodiment, each of the slat engagement members includes a slat connector having a body section with an adhesive such as glue or resin, along the top surface, and a removable covering layer for protecting the adhesive until the device is ready to be installed.

When the slat engagement members are secured onto a group of slats, movement of the main body causes the group of slats to transition between the open position and the closed position without affecting the position of the remainder of the blind assembly.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a venetian-style blind assembly in accordance with the background art.

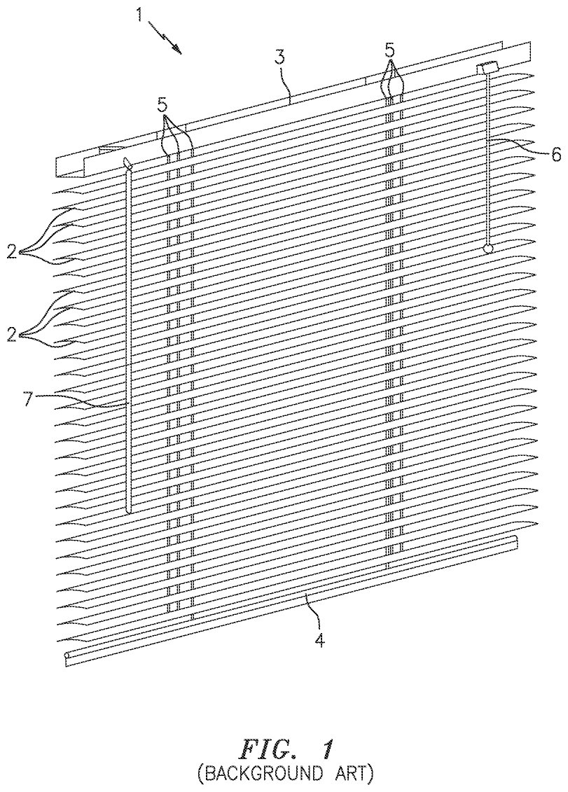

FIG. 2 is a side view of the secondary blind control device, in accordance with one embodiment of the invention.

FIG. 3 is a side view of the slat engagement member of the secondary blind control device, in accordance with one embodiment of the invention.

FIG. 4 is a perspective view of the secondary blind control device in operation, in accordance with one embodiment of the invention.

FIG. 5 is another perspective view of the secondary blind control device in operation, in accordance with one embodiment of the invention.

FIG. 6 is yet another perspective view of the secondary blind control device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about”, “approximately”, “substantially” and “generally” shall be used interchangeably to describe a feature, shape or measurement of a component within a tolerance such as, for example, manufacturing tolerances, measurement tolerances or the like.

As described herein, the term “removably secured”, and derivatives thereof shall be used to describe a situation wherein two or more objects are joined together in a non-permanent manner so as to allow the same objects to be repeatedly joined and separated.

As described herein, the term “pivotally connected” and derivatives thereof shall be used to describe a situation wherein two identified objects are joined together in a manner that allows one or both of the objects to pivot, move, and/or rotate about or in relation to the other object in one or more of a horizontal, diagonal or vertical manner.

As described throughout this document, the term “complementary shape”, and “complementary dimension”, shall be used to describe a shape and size of a component that is identical to, or substantially identical to the shape and size of another identified component within a tolerance such as, for example, manufacturing tolerances, measurement tolerances or the like.

As described herein, the term “connector” can include any number of different elements that work alone or together to repeatedly join two items together in either a nonpermanent manner or a permanent manner. Several nonlimiting examples include opposing strips of hook and loop material (i.e. Velcro®), attractively-oriented magnetic elements, tethers such as zip ties and string, and compression fittings such as buckles, clips, latches, hooks, snaps and buttons, for example. Each illustrated connector can be permanently secured to the illustrated portion of the device via a permanent sealer such as glue, resin, or welding, for example.

Although described herein for use with venetian-style blinds, this is for illustrative purposes only. As such, the inventive concepts described below may be utilized to impart additional functionality to blinds and components of many different shapes, sizes and orientations. Accordingly, the inventive concepts are not to be construed as limiting. Additionally, although described as a device for use with existing blinds, other embodiments are contemplated wherein the below described functionality is included in the design and manufacture of new blinds.

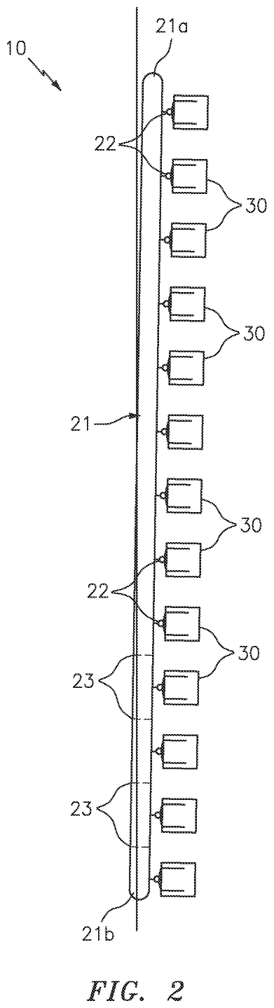

FIGS. 2-5 illustrate one embodiment of a secondary blind control device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper”, “bottom”, “right”, “left”, “front”, “vertical”, “horizontal”, and derivatives thereof shall relate to the invention as oriented in FIG. 2.

As shown at FIG. 2, one embodiment of the secondary blind control device 10 can include, essentially, a main body 21 having a plurality of slat engagement members 30 that are pivotally connected thereto.

In one embodiment, the main body 21 can include an elongated rod having a top end 21a, a bottom end 21b, and a plurality of loops 22. The main body can include any number of different lengths and/or may include a plurality of pre-scored lines 23, for example, that are disposed along a portion of the length of the main body. The scored lines functioning to allow a user to easily reduce the length of the main body by bending or cutting the rod along the line causing the material to separate.

In either instance, the main body 21 can include any number of different shapes and sizes, and may be formed from materials that are, for example, relatively strong and stiff for their weight. Several nonlimiting examples include, but are not limited to various plastic/polymers (e.g., high-density polyethylene (HDPE), rigid polyvinyl chloride (PVC), or polyethylene terephthalate (PET)), and/or various composite materials (e.g., carbon fibers in a polymer matrix, fiberglass, etc.).

As shown, each of the loops 22 can be positioned along the length of the main body and oriented so as so as to extend outward therefrom. In one embodiment, the loops 22 may be constructed from the same material as the main body, so as to be formed as a unitary element through known construction methodologies such as casting or molding, for example.

Of course, other embodiments are contemplated wherein the loops are formed from a different material to the main body and may be permanently or removably secured to the main body. For example, each of the loops 22 may comprise metallic eye hooks, for example, that are screwed into the side of the main body.

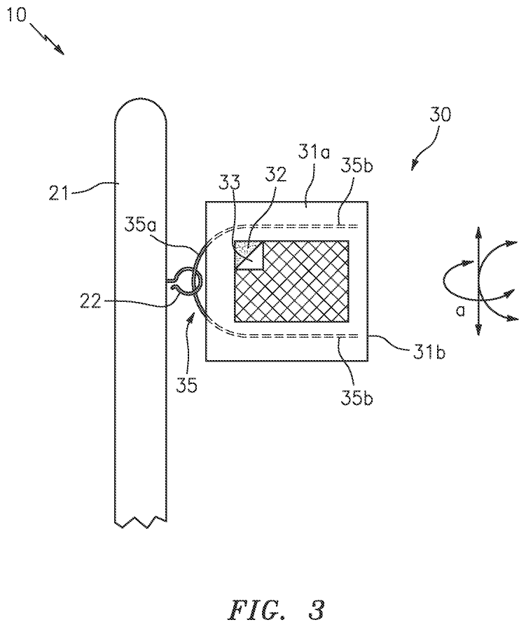

Although any number of different connectors can be used with the slat engagement member 30, the preferred embodiment of the device 10 can engage the slats of a venetian blind in a peel-and-stick manner. As such, FIG. 3 illustrates one embodiment of a slat engagement member 30 that includes an adhesive-backed slat connector 31 and a frame 35.

In one embodiment, the adhesive backed slat connector can include a body section having a top surface 31a and a bottom surface 31b. The connector body will preferably be constructed from a malleable material such as a thin sheet of Polyethylene, for example, so as to conform to the shape and curvature of a slat to which the body is to be secured.

In either instance, an adhesive 32 such as glue or resin, for example, can be positioned along the top surface of the connector, and a removable covering layer 33 can be provided to protect the adhesive until the device is ready to be installed.

In one embodiment, the frame 35 can include a generally U-shaped member having a middle portion 35a that is positioned through the opening of a single loop 22, and a pair of arms 35b that are attached to the connector body. In the preferred embodiment, the frame 35 can be constructed from a thin piece of slightly malleable steel wire that is bent to form the illustrated shape.

In various embodiments, the arms of the frames can be permanently secured to the connector body via a permanent adhesive or resin, and can be positioned on the top surface of the main body, the bottom surface of the main body or within the main body so as to be located between the top and bottom surfaces. Of course, other embodiments are contemplated wherein the frame includes any number of other shapes and/or wherein the frame and connector body are permanently or removably secured together using other types of attachment means/connectors.

By positioning the curved middle portion 31a of the U-shaped frame within the opening of a loop 22, the connector 31 is able to move in any number of different orientations (arrow a), relative to the main body 21 (i.e., pivotally secured). Of course, the inventive concepts are not limited to the use of a loop and U-frame assembly, as any number of other devices capable of pivotally securing the connector 31 to the main body 21 are also contemplated.

In operation, the device 10 can be permanently or removably secured onto any number of slats 2 on a venetian blind assembly 1 where it is desirable to provide a secondary control. More specifically, the device 10 can function to transition each of the connected slats between an open position and a closed position independent of the remainder of the slats on the same blind assembly.

In one embodiment, the engagement members 30 can include a uniform separation distance along the length of the main body. In the preferred embodiment, each device 10 can be manufactured to include a uniform separation distance that is approximately 87% of the width of the slat to which the device is intended to be engaged. For example, when sized to be used with blinds having 1-inch slats, the separation distance between each of the engagement members 30 can be approximately ⅞ of an inch.

This calculation and distance are specifically chosen so as to accommodate the overlap of the slats when in the closed position, and to ensure the engagement members are not visible on the other side of the slats when in use. Of course, other embodiments are contemplated wherein the separation distance is not uniform and/or wherein a different separation distance and/or calculation is provided.

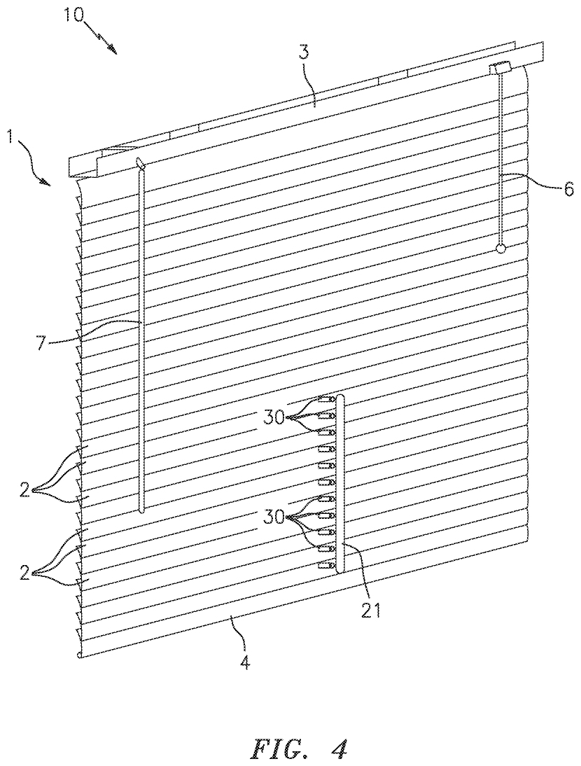

FIGS. 4-6 illustrate one embodiment of the secondary blind control device 10 in operation. As shown, with the blinds 1 in the fully lowered and closed position, the device 10 can be maneuvered so as to engage the slats 2 where independent control is desirable. This will typically be the lower half of the blinds as shown, although any other locations are also contemplated. When so positioned, each of the connectors 31 can be adhered to the inside-facing surface of the chosen slats 2, so as to be located on the bottom surface of the slats when in the open position.

With the device 10 installed, a user can use the traditional controls 6 and/or 7 to transition all of the slats between the open and closed position as normal. Moreover, the device 10 provides secondary control options to the user whereby movement of the rod 21 up or down causes each of the connected slats to transition to the opposite position of the remaining blinds.

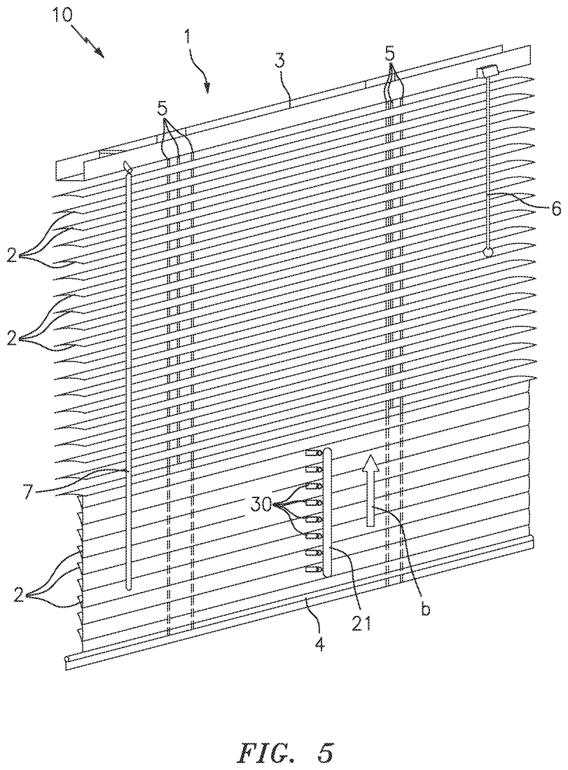

For example, FIG. 5 illustrates the device 10 wherein movement of the rod upward (arrow b) causes the connected slats 2 to transition to the closed position, while the remaining slats remain fully open. Such a feature beneficially providing complete privacy through the window in the area where the device is connected, while allowing maximum light to enter through the remainder of the window.

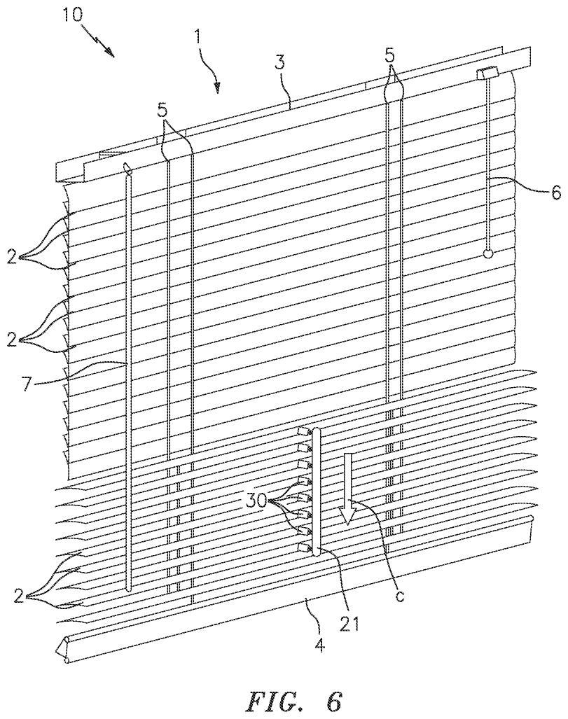

Conversely, FIG. 6 illustrates the device 10 wherein movement of the rod downward (arrow c) causes the connected slats 2 to transition to the open position, while the remaining slats remain fully closed. Such a feature beneficially providing the user with the ability to see out of the window in the area where the device is connected, while providing maximum shade from light to enter through the remainder of the window.

Although described above with regard to an adhesive connector, the inventive concepts are not so limiting. To this end, the slat connector 31 can include, comprise or consist of any number of other objects and/or connectors that are capable of engaging the slats of a blind in either a permanent or removable manner.

As described herein, one or more elements of the secondary blind control device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A control device for a venetian blind assembly having a top rail, a bottom rail, a plurality of horizontal slats, a lift controller and a tilt controller, said control device comprising:
a main body having a top end, a bottom end and a side surface; and
a plurality of slat engagement members that are pivotally connected along a length of the main body,
wherein movement of the main body selectively causes a portion of the plurality of horizontal slats to transition from an open position to a closed position.

2. The device of claim 1, wherein each of the plurality of slat engagement members comprises:
a slat connector having a top surface and a bottom surface; and
a frame, that is in communication with the slat connector.

3. The device of claim 2, further comprising:
a plurality of loops that are formed along a length of the main body.

4. The device of claim 3, wherein the frame of each of the plurality of slat engagement members is positioned through one of the plurality of loops.

5. The device of claim 2, wherein the slat connector includes functionality for selectively engaging one of the plurality of horizontal slats on the venetian blind assembly.

6. The device of claim 2, wherein the slat connector includes functionality for selectively engaging one of the plurality of horizontal slats on the venetian blind assembly in a peel and stick manner.

7. The device of claim 2, further comprising:
an adhesive material that is positioned along the top surface of the slat connector of each of the plurality of slat engagement members, said adhesive material being configured to engage one of the plurality of horizontal slats on the venetian blind assembly.

8. The device of claim 7, further comprising:
a cover layer that is removably positioned over the adhesive material.

9. The device of claim 1, wherein the main body comprises an elongated rod.

10. The device of claim 1, wherein each of the plurality of slat engagement members are positioned along the length of the rod at a uniform separation distance.

11. A venetian blind assembly, comprising:
a top rail;
a bottom rail;
a plurality of ladder strings that are positioned between the top rail and the bottom rail;
a plurality of horizontal slats that are in communication with the plurality of ladder strings;
a lift controller;
a tilt controller; and
a secondary control device that includes a main body having a top end, a bottom end and a side surface, and a plurality of slat engagement members that are pivotally connected along a length of the main body,
wherein movement of the main body selectively causes a portion of the plurality of horizontal slats to transition from an open position to a closed position.

12. The device of claim 11, wherein each of the plurality of slat engagement members comprises:
a slat connector having a top surface and a bottom surface; and
a frame, that is in communication with the slat connector.

13. The device of claim 12, further comprising:
a plurality of loops that are formed along a length of the main body.

14. The device of claim 13, wherein the frame of each of the plurality of slat engagement members is positioned through one of the plurality of loops.

15. The device of claim 12, wherein the slat connector includes functionality for selectively engaging one of the plurality of horizontal slats.

16. The device of claim 12, wherein the slat connector includes functionality for selectively engaging one of the plurality of horizontal slats in a peel and stick manner.

17. The device of claim 12, further comprising:
an adhesive material that is positioned along the top surface of the slat connector of each of the plurality of slat engagement members, said adhesive material being configured to engage one of the plurality of horizontal slats.

18. The device of claim 17, further comprising:
a cover layer that is removably positioned over the adhesive material.

19. The device of claim 11, wherein the main body comprises an elongated rod.

20. The device of claim 11, wherein each of the plurality of slat engagement members are positioned along the length of the rod at a uniform separation distance.
